(19) United States
(12) Patent Application Publication
(10) Pub. No.: US 2025/0153247 A1
(43) Pub. Date: May 15, 2025

(54) CHIP BREAKER POCKETS

(71) Applicant: KENNAMETAL INC., LATROBE, PA (US)

(72) Inventors: Cui Lu, Tianjin (CN); Jie Cai, Shanghai (CN); Wei Zhao, Tianjin (CN); Jianzhen Gao, Shanghai (CN); Jia Wang, Shanghai (CN)

(73) Assignee: KENNAMETAL INC., LATROBE, PA (US)

(21) Appl. No.: 18/926,856

(22) Filed: Oct. 25, 2024

(30) Foreign Application Priority Data
Nov. 9, 2023 (CN) 2023114852186

(51) Int. Cl. B23B 27/16

(52) U.S. Cl. CPC B23B 27/1659; B23B 2200/323

(57) ABSTRACT

A hole finishing tool includes a shank, a body, and a plurality of cutting inserts. The body extends axially from the shank. The body includes ribs. Each of the ribs include a respective pocket. Each cutting insert is attached to the respective pocket of the respective rib. Each cutting insert includes a cutting edge and a chip breaker pocket. The chip breaker pocket is disposed in a rake face of the cutting insert. The chip breaker pocket includes a front boundary and a chip wall. The front boundary is parallel to the cutting edge. The chip wall is disposed at a rotation angle relative to the cutting edge. The rotation angle ranges between 0° to 50°.

### FIELD OF THE DISCLOSURE

The disclosure relates to chip breaker pockets in hole finishing tools and cutting inserts.

### BACKGROUND

Hole finishing tools may be used to machine holes in workpieces. Due to the material of the workpiece, such as Aluminum or other material, the chips cut from the workpieces may be difficult to break, easy to entangle, may jam at the hole bottom, and may scratch the workpiece.

Hole finishing tools, and methods of cutting workpieces, are needed to reduce or eliminate one or more issues associated with the existing hole finishing tools and methods of their use.

### SUMMARY

In one embodiment, a hole finishing tool is provided. The hole finishing tool includes a shank, a body, and a plurality of cutting inserts. The body extends axially from the shank. The body includes ribs. Each of the ribs include a respective pocket. Each cutting insert is attached to the respective pocket of the respective rib. Each cutting insert includes a cutting edge and a chip breaker pocket. The chip breaker pocket is disposed in a rake face of the cutting insert. The chip breaker pocket includes a front boundary and a chip wall. The front boundary is parallel to the cutting edge. The chip wall is disposed at a rotation angle relative to the cutting edge. The rotation angle ranges between 0° to 50°.

In another embodiment, a cutting insert is provided. The cutting insert includes a cutting edge and a chip breaker pocket. The chip breaker pocket is disposed in a rake face of the cutting insert. The chip breaker pocket includes a front boundary and a chip wall. The front boundary is parallel to the cutting edge. The chip wall is disposed at a rotation angle relative to the cutting edge. The rotation angle ranges between 0° to 50°.

In still another embodiment, a method of cutting a workpiece is provided. In one step, a hole finishing tool is rotated to cut a workpiece. In another step, a chip cut from the workpiece is flowed into a chip breaker pocket of the hole finishing tool. In an additional step, the chip is curled off a surface of the chip breaker pocket to cause it to turn over and flow backwards onto the workpiece. Then, in another step, the chip is broken against the workpiece.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of one embodiment of a hole finishing tool with attached cutting inserts;

FIG. 2 illustrates a cross-sectional side view through one embodiment of a cutting insert which may be utilized in the hole finishing tool of FIG. 1;

FIG. 3 illustrates a top view through the cutting insert of the embodiment of FIG. 2;

FIG. 4 illustrates a partial perspective view of one embodiment of a cutting insert, cutting a chip of a workpiece, which may be utilized in the hole finishing tool of FIG. 1;

FIG. 5 illustrates a partial perspective view showing the cut-away area identified in FIG. 1 which further illustrates the cutting insert of FIG. 4 without showing the chip;

FIG. 6 illustrates a cross-sectional side view through line 6-6 of the cutting insert of FIG. 7;

FIG. 7 illustrates a top view through the cutting insert of the embodiment of FIGS. 4-5;

FIG. 8 illustrates a partial perspective view of another embodiment of a cutting insert, cutting a chip of a workpiece, which may be utilized in the hole finishing tool of FIG. 1;

FIG. 9 illustrates a partial perspective view showing the cut-away area identified in FIG. 1 which further illustrates the cutting insert of FIG. 8 without showing the chip;

FIG. 10 illustrates a cross-sectional side view through line 10-10 of the cutting insert of FIG. 11;

FIG. 11 illustrates a top view through the cutting insert of the embodiment of FIGS. 8-9;

FIG. 12 illustrates a partial perspective view of still another embodiment of a cutting insert, cutting a chip of a workpiece, which may be utilized in the hole finishing tool of FIG. 1;

FIG. 13 illustrates a partial perspective view showing the cut-away area identified in FIG. 1 which further illustrates the cutting insert of FIG. 12 without showing the chip;

FIG. 14 illustrates a cross-sectional side view through line 14-14 of the cutting insert of FIG. 15;

FIG. 15 illustrates a top view through the cutting insert of the embodiment of FIGS. 12-13;

FIG. 16 is a flowchart illustrating one embodiment of a method of cutting a workpiece.

### DETAILED DESCRIPTION

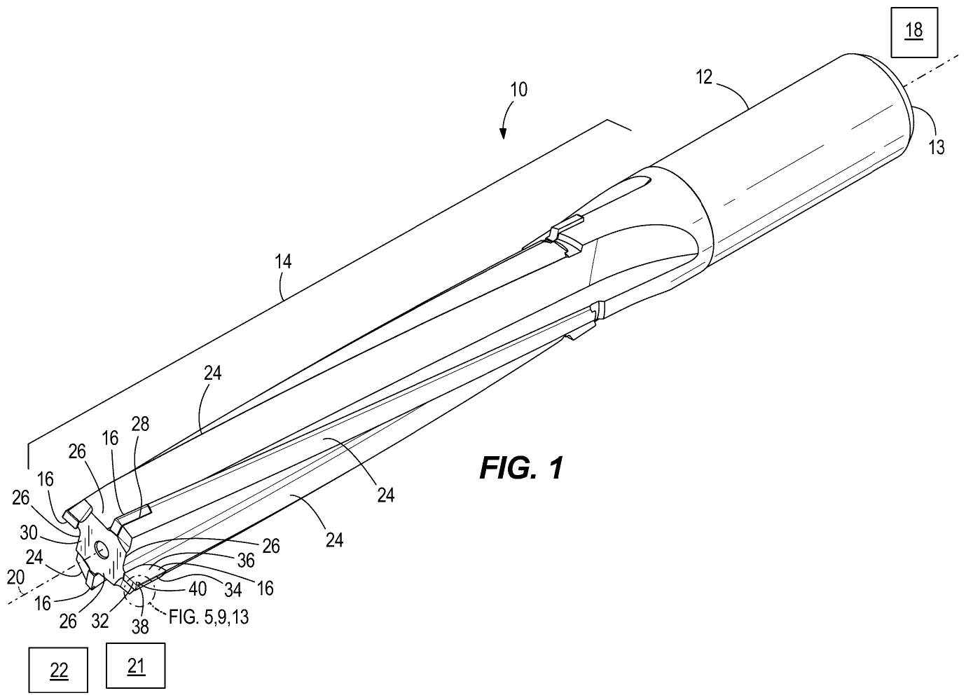

As illustrated in FIG. 1, in one embodiment a hole finishing tool 10 may comprise a shank 12, a body 14, and a plurality of cutting inserts 16. The hole finishing tool 10 may comprise an indexable hole finishing tool. In another embodiment, the hole finishing tool 10 may comprise a modular hole finishing tool. The hole finishing tool 10 may be made of steel. The hole finishing tool 10 may comprise a Polycrystalline Diamond cutting tool. In other embodiments, the hole finishing tool 10 may vary in type or material. The shank 12, at a back end 13 of the hole finishing tool 10, may be attached to a machine 18 configured to rotate the hole finishing tool around axis 20 to cut a chip 21 off the workpiece 22. The body 14 may extend axially from the shank 12. The body 14 may comprise alternating helical ribs 24 and helical flutes 26. Each of the cutting inserts 16 may be attached to respective pockets 28 of the helical ribs 24 at a front end 30 of the hole finishing tool 10. The cutting inserts 16 may be disposed adjacent to the respective helical flutes 26. Each cutting insert 16 may comprise a front edge 32, an outer diameter edge 34, a rake face 36, a cutting edge 38, and a chip breaker pocket 40. In other embodiments, the hole finishing tool 10 including its components may comprise varying configurations, shapes, sizes, and orientations.

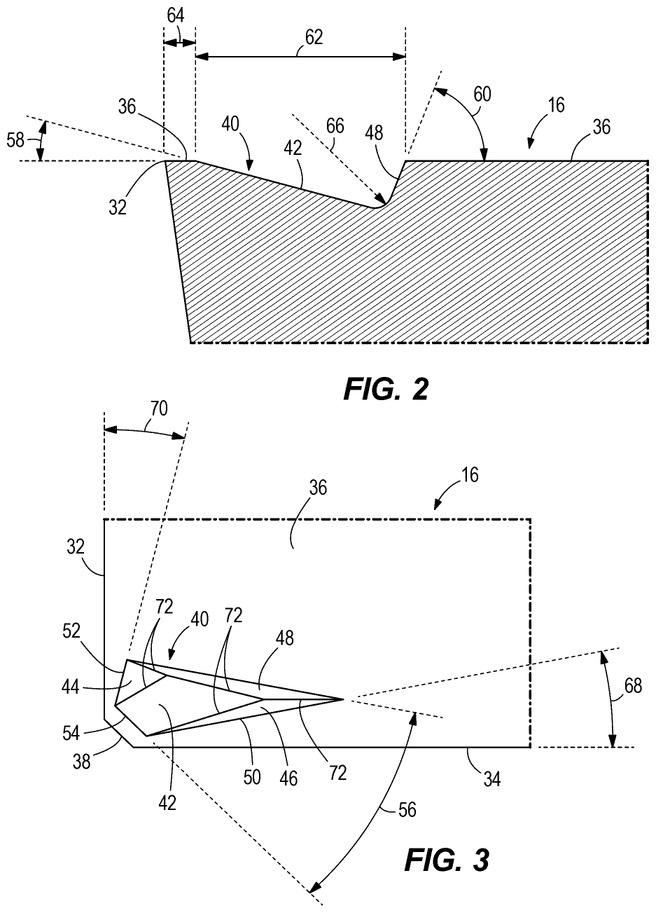

As illustrated in FIGS. 2-3, in one illustrative embodiment each cutting insert 16 may comprise the front edge 32, the outer diameter edge 34, the rake face 36, the cutting edge 38, and the chip breaker pocket 40. The chip breaker pocket 40 may be disposed in the rake face 36. The chip breaker pocket 40 may comprise a bottom surface 42, side surfaces 44 and 46, and chip wall 48. The chip breaker pocket 40 may further comprise side edges 50 and 52. A front boundary 54 of the chip breaker pocket 40 may be parallel to the cutting edge 38 of the cutting insert 16. The chip wall 48 may be disposed at a rotation angle 56 relative to the cutting edge 38 of the cutting insert 16. The rotation angle 56, in varying embodiments, may range between 0° to 50°. The backwards flow of the chip cut from the workpiece by the cutting edge 38 of the cutting insert 16 may be controlled by changing the rotation angle 56 of the chip wall 48 relative to the cutting edge 38 of the cutting insert 16. The bottom surface 42 may be disposed at a rake angle 58 relative to the rake face 36. The rake angle 58, in varying embodiments, may range between 15° to 20°. The chip wall 48 may be disposed at a chip wall angle 60 relative to the rake face 36. The chip wall angle 60, in varying embodiments, may range between 60° to 80°.

The chip breaker pocket 40 may comprise a groove width 62. The groove width 62, in varying embodiments, may range between 0.5 mm to 1.0 mm. Each cutting insert 16 may have a land width 64 between the cutting edge 38 and the chip breaker pocket 40. The land width 64, in varying embodiments, may range between 0.05 mm to 0.12 mm. There may be a transition radius 66 between the chip wall 48 and the bottom surface 42 of the chip breaker pocket 40. The transition radius 66, in varying embodiments, may range between 0.05 mm to 0.1 mm. The side edge 50 of the chip breaker pocket 40 may be disposed at a retraction angle 68 relative to the outer diameter edge 34 of the cutting insert 16. The retraction angle 68, in varying embodiments, may range between 5° to 15°. The side edge 52 of the chip breaker pocket 40 may be disposed at a retraction angle 70 relative to the front edge 32 of the cutting insert 16. The retraction angle 70, in varying embodiments, may range between 0° to 45°. The chip breaker pocket 40 may further comprise rounded corners 72 transitioning between the bottom surface 42, side surfaces 44 and 46, and chip wall 48. The rounded corners 72 and slope/angles of the bottom surface 42, side surfaces 44 and 46, and chip wall 48 may provide edge strength. In other embodiments, each cutting insert 16 and its chip breaker pocket 40 may vary in shape, configuration, and size.

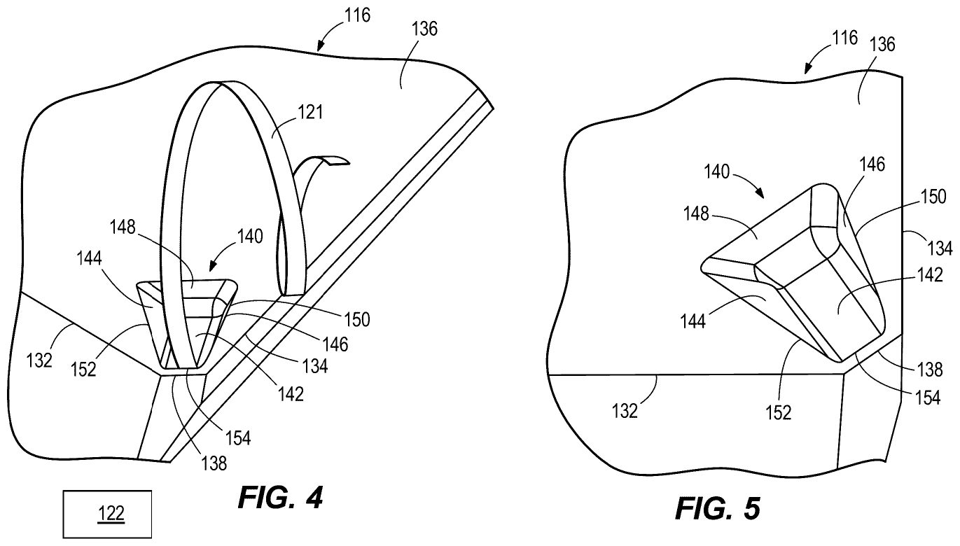

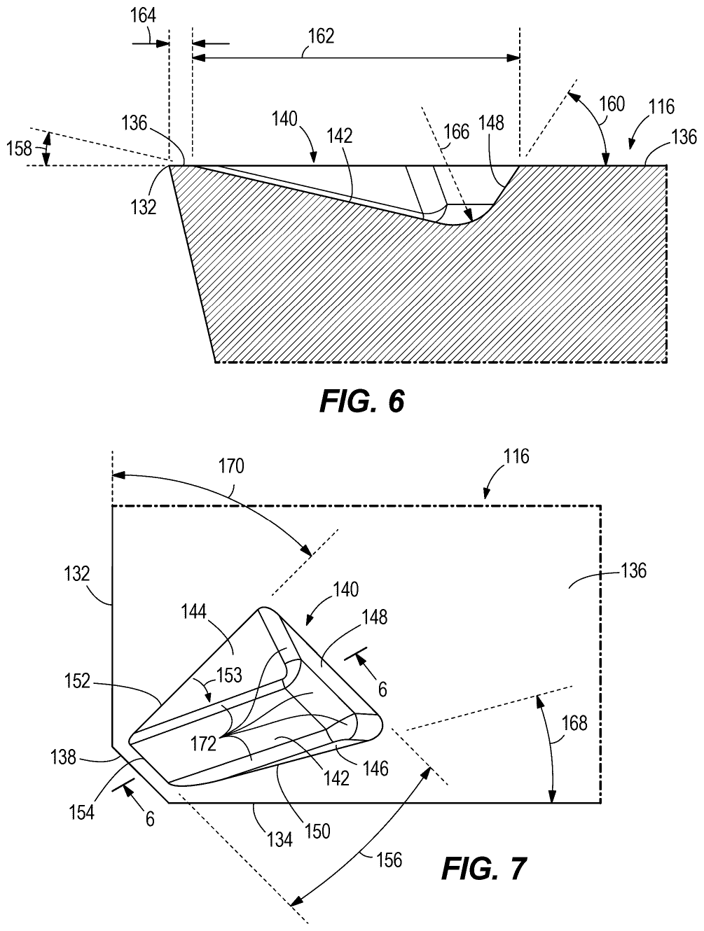

As illustrated in FIGS. 4-7, in another embodiment each cutting insert 116 may comprise a front edge 132, an outer diameter edge 134, a rake face 136, a cutting edge 138, and a chip breaker pocket 140. The chip breaker pocket 140 may be disposed in the rake face 136. The chip breaker pocket 140 may comprise a bottom surface 142, side surfaces 144 and 146, and chip wall 148. The chip breaker pocket 140 may further comprise side edges 150 and 152. Side edge 152 may be perpendicular to the cutting edge 138 of the cutting insert 116, and side surface 144 may have a slope 153 of 30°. The side edge 152 may cause a chip 121 of the workpiece 122 cut by the cutting edge 138 of the cutting insert 116 to turn over causing the chip 121 to flow backwards. A front boundary 154 of the chip breaker pocket 140 may be parallel to the cutting edge 138 of the cutting insert 116. The chip wall 148 may be disposed at a rotation angle 156 relative to the cutting edge 138 of the cutting insert 116. The rotation angle 156 may be 0° so that the chip wall 148 is parallel to the cutting edge 138 of the cutting insert 116.

The chip 121 of the workpiece 122 cut by the cutting edge 138 of the cutting insert 116 may hit the chip wall 148 vertically so that there is negligible velocity difference on both sides of the chip 121. The chip wall 148 may cause the chip 121 to curl and flow to the workpiece 122. This may cause the chip 121 to break when it first hits the workpiece 122 resulting in a shorter chip 121. The bottom surface 142 may be disposed at a rake angle 158 relative to the rake face 136. The rake angle 158 may be 15°. The chip wall 148 may be disposed at a chip wall angle 160 relative to the rake face 136. The chip wall angle 160 may be 60°. The chip breaker pocket 140 may comprise a groove width 162. The groove width 162 may be 0.7 mm. Each cutting insert 116 may have a land width 164 between the cutting edge 138 and the chip breaker pocket 140. The land width 164 may be 0.05 mm. The groove width 162 of 0.7 mm and the land width 164 of 0.05 mm may make the curling radius of the chip 121 smaller.

There may be a transition radius 166 between the chip wall 148 and the bottom surface 142 of the chip breaker pocket 140. The transition radius 166 may be 0.06 mm. The side edge 150 of the chip breaker pocket 140 may be disposed at a retraction angle 168 relative to the outer diameter edge 134 of the cutting insert 116. The retraction angle 168 may be 15°. The side edge 152 of the chip breaker pocket 140 may be disposed at a retraction angle 170 relative to the front edge 132 of the cutting insert 116. The retraction angle 170 may be 45°. The chip breaker pocket 140 may further comprise rounded corners 172 transitioning between the bottom surface 142, side surfaces 144 and 146, and chip wall 148. The rounded corners 172 and slopes/angles of the bottom surface 142, side surfaces 144 and 146, and chip wall 148 may provide edge strength. In other embodiments, each cutting insert 116 and its chip breaker pocket 140 may vary in shape, configuration, and size.

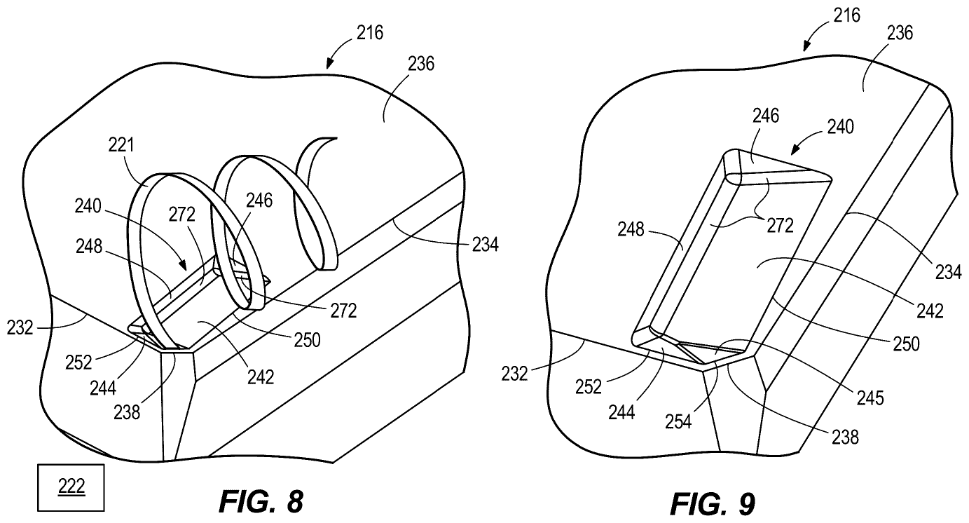

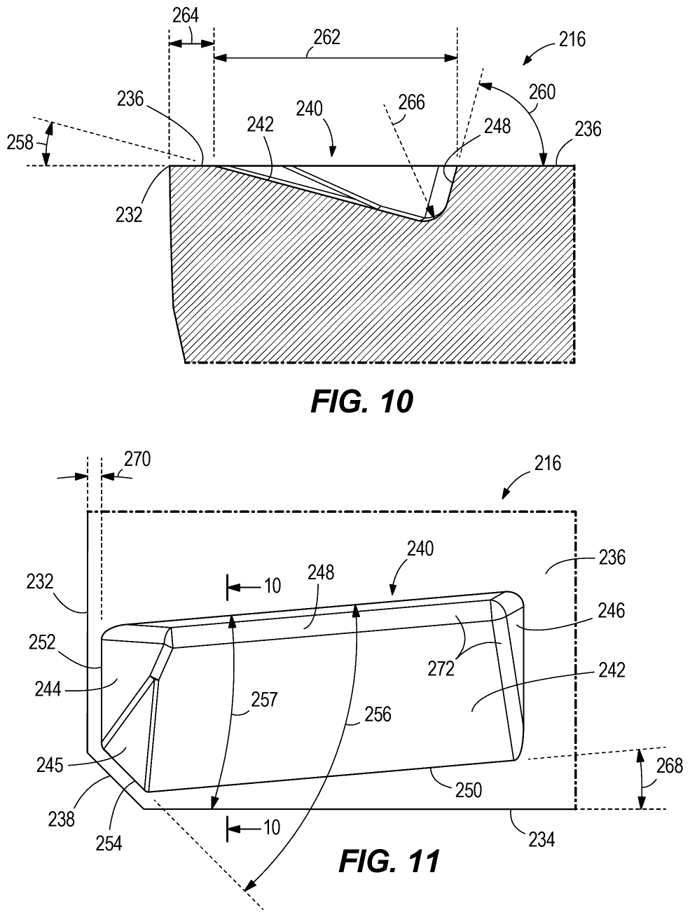

As illustrated in FIGS. 8-11, in another embodiment each cutting insert 216 may comprise a front edge 232, an outer diameter edge 234, a rake face 236, a cutting edge 238, and a chip breaker pocket 240. The chip breaker pocket 240 may be disposed in the rake face 236 in a radial configuration. The chip breaker pocket 240 may comprise a bottom surface 242, side surfaces 244, 245, and 246, and chip wall 248. The chip breaker pocket 240 may further comprise side edges 250 and 252. A front boundary 254 of the chip breaker pocket 240 may be parallel to the cutting edge 238 of the cutting insert 216. The chip wall 248 may be disposed at a rotation angle 256 relative to the cutting edge 238 of the cutting insert 216. The rotation angle 256 may be 50°. The chip wall 248 may be disposed at an angle 257 relative to the outer diameter edge 234. The angle 257 may be 5° which, in combination with the radial configuration of the chip breaker pocket 240, may cause a chip 221 of the workpiece 222 cut by the cutting edge 238 of the cutting insert 216 to turn over and flow backwards.

The chip wall 248 may cause the chip 221 cut by the cutting edge 238 of the workpiece 222 to curl upward after hitting the chip wall 248. Due to the angle that the chip 221 hits the chip wall 248, the chip 221 may twist, deform, evacuate backwards, hit the workpiece surface 222, and continue to curl and hit the workpiece surface 222 multiple times until the chip 221 breaks into multiple, short spiral chips 221. The bottom surface 242 may be disposed at a rake angle 258 relative to the rake face 236. The rake angle 258 may be 15°. The chip wall 248 may be disposed at a chip wall angle 260 relative to the rake face 236. The chip wall angle 260 may be 75° to enhance the curling effect of the chip 221. The chip breaker pocket 240 may comprise a groove width 262. The groove width 262 may be 0.6 mm. Each cutting insert 216 may have a land width 264 between the cutting edge 238 and the chip breaker pocket 240. The land width 264 may be 0.05 mm. The groove width 262 of 0.6 mm and the land width 264 of 0.05 mm may make the curling radius of the chip 221 smaller.

There may be a transition radius 266 between the chip wall 248 and the bottom surface 242 of the chip breaker pocket 240. The transition radius 266 may be 0.05 mm. The side edge 250 of the chip breaker pocket 240 may be disposed at a retraction angle 268 relative to the outer diameter edge 234 of the cutting insert 216. The retraction angle 268 may be 5°. The side edge 252 of the chip breaker pocket 240 may be disposed at a retraction angle 270 relative to the front edge 232 of the cutting insert 216. The retraction angle 270 may be 0°. The chip breaker pocket 240 may further comprise rounded corners 272 transitioning between the bottom surface 242, side surfaces 244, 245, and 246, and chip wall 248. The rounded corners 272 and slopes/angles of the bottom surface 242, side surfaces 244, 245, and 246, and chip wall 248 may provide edge strength. In other embodiments, each cutting insert 216 and its chip breaker pocket 240 may vary in shape, configuration, and size.

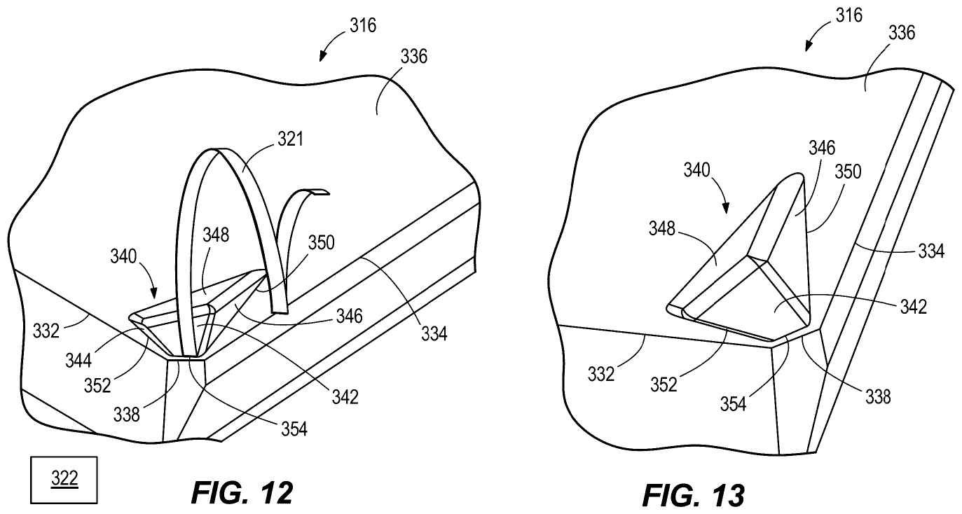

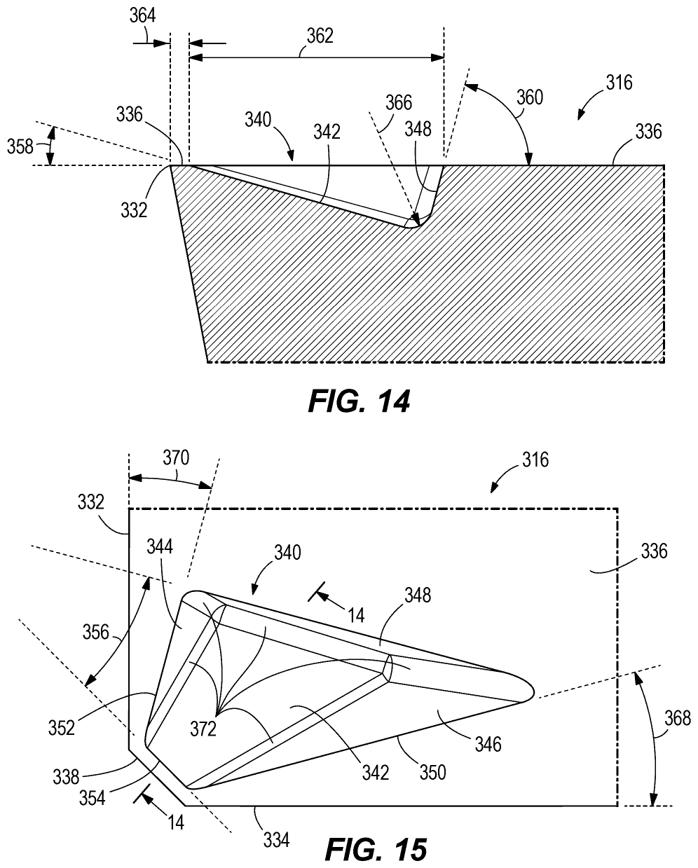

As illustrated in FIGS. 12-15, in another embodiment each cutting insert 316 may comprise a front edge 332, an outer diameter edge 334, a rake face 336, a cutting edge 338, and a chip breaker pocket 340. The chip breaker pocket 340 may be disposed in the rake face 336. The chip breaker pocket 340 may be trapezoidal which may provide edge strength. The chip breaker pocket 340 may comprise a bottom surface 342, side surfaces 344 and 346, and chip wall 348. The chip breaker pocket 340 may further comprise side edges 350 and 352. A front boundary 354 of the chip breaker pocket 340 may be parallel to the cutting edge 338 of the cutting insert 316. The chip wall 348 may be disposed backwards at a rotation angle 356 relative to the cutting edge 338 of the cutting insert 316. The rotation angle 356 may be 30°.

The chip wall 348 may cause the chip 321 of the workpiece 322 cut by the cutting edge 338 of the cutting insert 316 to continuously curl and flow backwards to the workpiece 322. The chip 321 may break when it hits the workpiece 322. The curling radius of the chip 321 may be affected by the configuration and may change from a large curling radius to a small curling radius. The bottom surface 342 may be disposed at a rake angle 358 relative to the rake face 336. The rake angle 358 may be 15°. The chip wall 348 may be disposed at a chip wall angle 360 relative to the rake face 336. The chip wall angle 360 may be 75°. The chip breaker pocket 340 may comprise a groove width 362. The groove width 362 may be 0.5 mm. Each cutting insert 316 may have a land width 364 between the cutting edge 338 and the chip breaker pocket 340. The land width 364 may be 0.05 mm. The groove width 362 of 0.5 mm and the land width 364 of 0.05 mm may make the curling radius of the chip 321 smaller.

There may be a transition radius 366 between the chip wall 348 and the bottom surface 342 of the chip breaker pocket 340. The transition radius 366 may be 0.06 mm. The side edge 350 of the chip breaker pocket 340 may be disposed at a retraction angle 368 relative to the outer diameter edge 334 of the cutting insert 316. The retraction angle 368 may be 15°. The side edge 352 of the chip breaker pocket 340 may be disposed at a retraction angle 370 relative to the front edge 332 of the cutting insert 316. The retraction angle 370 may be 15°. The chip breaker pocket 340 may further comprise rounded corners 372 transitioning between the bottom surface 342, side surfaces 344 and 346, and chip wall 348. The rounded corners 372 and slopes/angles of the bottom surface 342, side surfaces 344 and 346, and chip wall 348 may provide edge strength. In other embodiments, each cutting insert 316 and its chip breaker pocket 340 may vary in shape, configuration, and size.

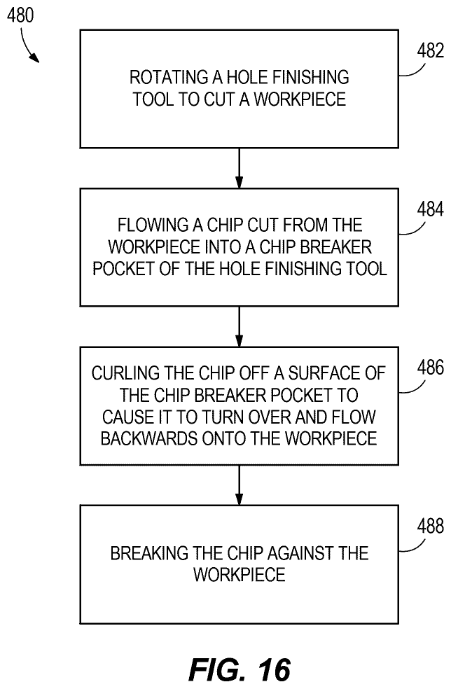

As shown in FIG. 16, in one embodiment a method 480 of cutting a workpiece is provided. The method 480 may utilize any of the hole finishing tools 10, cutting inserts 16, 116, 216, and 316, and chip breaker pockets 40, 140, 240, and 340 disclosed herein. In other embodiments, the method 480 may utilize varying hole finishing tools, cutting inserts, and chip breaker pockets.

In step 482, a hole finishing tool may be rotated to cut a workpiece. In step 484, a chip cut from the workpiece may flow into a chip breaker pocket of the hole finishing tool. In step 486, the chip may be curled off a surface of the chip breaker pocket to cause it to turn over and flow backwards onto the workpiece. Then, in step 488, the chip may break against the workpiece.

In one embodiment, the method 480 may further comprise the step of the chip hitting a chip wall of the chip breaker pocket vertically. The chip may hit the chip wall of the chip breaker pocket with negligible velocity difference on opposed sides of the chip.

In another embodiment, the method 480 may further comprise the chip breaking the first time it contacts the workpiece.

In an additional embodiment, the method 480 may further comprise the chip hitting a chip wall of the chip breaker and then curling upwards.

In yet another embodiment, the method 480 may further comprise the chip, after curling upwards, twisting, deforming, and flowing backwards onto the workpiece.

In still another embodiment, the method 480 may further comprise the chip, after it flows backwards onto the workpiece, curling multiple times and then breaking into spiral chips.

In other embodiments, one or more steps of the method 480 may not be followed, one or more steps of the method 480 may be varied in substance and/or in order, and/or one or more additional steps may be added to the method 480.

One or more embodiments of the disclosure may be used to cut difficult materials such as aluminum in order to increase the plastic deformation of the chip, to break the chip easier in a shorter time, to increasing curling of the chip, to increase control of the flow and direction of the chip, to increase the edge strength of the chip breaker pocket, to maintain the strength of the cutting edge of the cutting insert, and to reduce scratching of the workpiece by the chip. The chip breaker pocket may be a simple structure, and may be easy to manufacture through laser forming processing or other manufacturing methods. In other embodiments, one or more additional issues associated with the current hole finishing tools and methods of their use may be reduced or eliminated.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A hole finishing tool comprising:
a shank;
a body extending axially from the shank, the body comprising ribs, each of the ribs comprising a respective pocket; and
a plurality of cutting inserts, each cutting insert attached to the respective pocket of the respective rib;
wherein each cutting insert comprises:
a cutting edge; and
a chip breaker pocket disposed in a rake face, the chip breaker pocket comprising:
a front boundary parallel to the cutting edge; and
a chip wall disposed at a rotation angle relative to the cutting edge, the rotation angle ranging between 0° to 50°.

2. The hole finishing tool of claim 1 wherein the chip breaker pocket further comprises a bottom surface, the bottom surface disposed at a rake angle relative to the rake face, the rake angle ranging between 15° to 20°.

3. The hole finishing tool of claim 1 wherein the chip wall is disposed at a chip wall angle relative to the rake face, the chip wall angle ranging between 60° to 80°.

4. The hole finishing tool of claim 1 wherein the chip breaker pocket comprises a groove width ranging between 0.5 mm to 1.0 mm.

5. The hole finishing tool of claim 1 further comprising a land width between the cutting edge and the chip breaker pocket ranging between 0.05 mm to 0.12 mm.

6. The hole finishing tool of claim 1 wherein the chip breaker pocket further comprises a bottom surface, a transition radius between the chip wall and the bottom surface ranging between 0.05 mm to 0.1 mm.

7. The hole finishing tool of claim 1 wherein the chip breaker pocket further comprises a side edge and the cutting insert further comprises an outer diameter edge, the side edge disposed at a retraction angle relative to the outer diameter edge, the retraction angle ranging between 5° to 15°.

8. The hole finishing tool of claim 1 wherein the chip breaker pocket further comprises a side edge and the cutting insert further comprises a front edge, the side edge disposed at a retraction angle relative to the front edge, the retraction angle ranging between 0° to 45°.

9. The hole finishing tool of claim 1 wherein the chip breaker pocket further comprises rounded corners between surfaces of the chip breaker pocket.

10. A cutting insert comprising:
a cutting edge; and
a chip breaker pocket disposed in a rake face, the chip breaker pocket comprising:
a front boundary parallel to the cutting edge; and
a chip wall disposed at a rotation angle relative to the cutting edge, the rotation angle ranging between 0° to 50°.

11. The cutting insert of claim 10 wherein the chip breaker pocket further comprises a bottom surface, the bottom surface disposed at a rake angle relative to the rake face, the rake angle ranging between 15° to 20°.

12. The cutting insert of claim 10 wherein the chip wall is disposed at a chip wall angle relative to the rake face, the chip wall angle ranging between 60° to 80°.

13. The cutting insert of claim 10 wherein the chip breaker pocket comprises a groove width ranging between 0.5 mm to 1.0 mm.

14. The cutting insert of claim 10 further comprising a land width between the cutting edge and the chip breaker pocket ranging between 0.05 mm to 0.12 mm.

15. The cutting insert of claim 10 wherein the chip breaker pocket further comprises a bottom surface, a transition radius between the chip wall and the bottom surface ranging between 0.05 mm to 0.1 mm.

16. The cutting insert of claim 10 wherein the chip breaker pocket further comprises a side edge and the cutting insert further comprises an outer diameter edge, the side edge disposed at a retraction angle relative to the outer diameter edge, the retraction angle ranging between 5° to 15°.

17. The cutting insert of claim 10 wherein the chip breaker pocket further comprises a side edge and the cutting insert further comprises a front edge, the side edge disposed at a retraction angle relative to the front edge, the retraction angle ranging between 0° to 45°.

18. The cutting insert of claim 10 wherein the chip breaker pocket further comprises rounded corners between surfaces of the chip breaker pocket.

19. A method of cutting a workpiece comprising:
rotating a hole finishing tool to cut the workpiece;
flowing a chip cut from the workpiece into a chip breaker pocket of the hole finishing tool;
curling the chip off a surface of the chip breaker pocket to cause it to turn over and flow backwards onto the workpiece; and then
breaking the chip against the workpiece.

20. The method of claim 19 further comprising the chip hitting a chip wall of the chip breaker pocket vertically.

21. The method of claim 20 further comprising the chip hitting the chip wall of the chip breaker pocket with negligible velocity difference on opposed sides of the chip.

22. The method of claim 19 further comprising the chip breaking the first time it contacts the workpiece.

23. The method of claim 19 further comprising the chip hitting a chip wall of the chip breaker and then curling upwards.

24. The method of claim 23 further comprising the chip, after curling upwards, twisting, deforming, and flowing backwards onto the workpiece.

25. The method of claim 24 further comprising the chip, after it flows backwards onto the workpiece, curling multiple times and then breaking into spiral chips.
